(19) United States
(12) Patent Application Publication
(10) Pub. No.: US 2021/0270373 A1
(43) Pub. Date: Sep. 2, 2021

(54) HYDRODYNAMICALLY EFFECTIVE SEAL COLLAR AND ROTARY UNION COMPRISING SUCH A SEAL COLLAR

(71) Applicant: Konzelmann GmbH, Löchgau (DE)

(72) Inventor: Andreas Laage, Bietigheim-Bissingen (DE)

(21) Appl. No.: 17/252,351

(22) PCT Filed: Jun. 12, 2019
(86) PCT No.: PCT/EP2019/065284

§ 371 Date: Dec. 15, 2020

(30) Foreign Application Priority Data
Jun. 19, 2018 (DE) 10 2018 114 701.5

(51) Int. Cl. F16J 15/44

(52) U.S. Cl. CPC F16J 15/441

(57) ABSTRACT

The invention relates to a seal collar, as are used for sealing rotary unions of rotating shafts against a surrounding housing, and a matching rotary union. To this end, provision is made that a radial chamfer hydrodynamically effective in the radial direction is provided at the at least one flank of the seal collar, which radial chamfer transitions to a flank surface of the flank at an angle α towards the clamping surface, in that the hydrodynamically effective radial chamfer has an extension in the radial direction of ≥0.3 mm, preferably ≥0.5 mm and in that the hydrodynamically effective radial chamfer has a maximum axial depth in the range of 20 μm to 50 μm relative to the flank surface. Further, provision is made that the clamping surface facing the at least one lateral sealing flank is converted at a falling angle β into an axial chamfer, which is hydrodynamically effective in the axial direction.

The hydrodynamically effective radial or axial chamfer provides a low-friction and low-wear seal collar.

The invention relates to a seal collar for installation in a groove on a shaft or in a groove in a housing for sealing a rotating shaft relative to a stationary housing or the like, having at least one lateral flank for contact and sealing on a side wall of the groove on a shaft or the groove in a housing and having a clamping surface directly or indirectly adjoining the flank at an angle for contact and sealing at the housing facing the groove on the shaft on the shaft facing the groove in a housing.

The invention further relates to a rotary union having a rotatable shaft and a housing or the like at least partially enclosing the shaft, wherein a pressure chamber is arranged between the shaft and the housing, which is sealed in the axial direction in each case by a seal collar arranged in a groove on a shaft or a groove in a housing, wherein the seal collar has a lateral flank for contact and sealing on a side wall of the groove on a shaft or the groove in a housing and a clamping surface adjoining the flank indirectly or directly at an angle for contact and sealing on the housing facing the groove on a shaft or on the shaft facing the groove in a housing.

For various types of automotive transmissions, provision is made to shift actuators by means of pressurized oil. The oil is routed to the respective actuators through a central, axially oriented drilled bore of a rotating shaft. Rotary unions for routing the oil from stationary gear parts into the central bore of the shaft are known. In such rotary unions, a pressure chamber is formed circumferential to the shaft. High pressure is used to feed the oil for shifting into the pressure chamber from the outside. At least one radially oriented drilled hole is routed from the pressure chamber to the central bore of the shaft as an oil supply. Seal collars are used to laterally seal the pressure chamber, such that the oil cannot or can only to a small extent flow out through a gap such as that formed between the rotating shaft and the stationary housing enclosing the shaft. The seal collar is usually designed as a rectangular seal collar, which can be opened or closed using an interlock. Such a seal collar is then arranged in a circumferential groove in the shaft and its outer clamping surface rests against the housing. The oil pressure presses the outer clamping surface of the seal collar against the housing and its flank facing away from the pressure chamber against the side wall of the groove facing away from the pressure chamber. In this way, the flank and the circumferential surface of the seal collar seal the outer exit gap formed between the shaft and the housing.

In an alternative design, the groove can also be arranged in the housing and the seal collar can be held in this groove. The inner circumferential surface of the seal collar then forms the clamping surface, which is used to press it against the surface of the shaft facing the groove.

To achieve low leakage, it is advantageous to press the seal collars against the respective opposing surfaces at a high surface pressure. However, this results in high friction losses, which in turn cause increased fuel consumption. As shown in the publicly accessible dissertation “Investigations on function and design of rectangular seals for rotating connections” (Mirco Gronitzki, Gottfried Wilhelm Leibniz University Hanover, 2006), friction can be reduced by a hydrostatic relief stage. In such a hydrostatic relief stage, the flank of the seal collar is set back in its area facing away from the clamping surface, for instance by a step or by a bevel, in relation to the flank area resting against the side wall of the groove. This reduces the contact surface of the flank facing away from the pressure chamber and the side wall of the groove. At the same time, the pressurized oil passes between the flank and the side wall of the groove in the area of the relief stage. It thus counteracts the oil pressure acting on the flank facing the pressure chamber. This reduces the force with which the non-recessed area of the flank is pressed against the side wall of the groove, resulting in reduced friction. The relief stage entails a reduced contact area between the seal collar and the side wall of the groove and at the same time a sufficiently large cross section of the seal collar for the required mechanical stability. Furthermore, the relief stage results in an increased material thickness of the seal collar in radial direction, which results in a reduction of the radial contact pressure of the seal collar and thus a reduction of the friction along its clamping surface.

As further specified in the dissertation, hydrodynamically acting structures can also be provided on the seal collar. Such hydrodynamically acting structures are formed of recesses in the flanks of the seal collar, which form bevels rising against the direction of rotation of the seal collar. This causes the oil pressure to rise, in particular in the area of the ends of the bevels, relieving the pressure on the sliding surface.

A sealing arrangement for sealing a rotary union for fluids between a shaft and a housing is known from EP 1 992 851 B1. Hydrodynamic structures acting in the direction of rotation are incorporated both on the flanks and at the circumferential surface of the seal collar. These form bevels rising against the direction of rotation, the width of which bevels is additionally reduced against the direction of rotation. The oil gap in the area of the hydrodynamically acting structures is thus reduced in its cross-section against the direction of rotation both by the rising bevels and by the decreasing width of the structures, achieving an additional increase in the hydrodynamic pressure build-up and thus an additional relief of the sliding surfaces. Because the hydrodynamically acting structures are provided both on the flanks and at the circumferential surface of the seal collar, friction losses can be reduced further. The disadvantage of such circumferentially oriented, hydrodynamically acting structures is the high manufacturing cost. This applies in particular to seal collars made of metal, where the structures, which are only a few micrometers deep, have to be inserted into the flanks and the circumferential surfaces in a periodic sequence.

US 2006/0055119 A1 shows a seal collar for a rotary union, which can be inserted into a groove. The circumferential surface of the seal collar rests against a housing enclosing the shaft and one flank of the seal collar rests against a side wall of the groove and the oil pressure presses it against the housing and the side wall of the groove. To be able to compensate for manufacturing tolerances regarding the observance of the groove width across its entire height, the seal collar has chamfers of various gradients in the flanks at its end facing away from the outer circumferential surface. The chamfers of various gradients alternate periodically in the circumferential direction, wherein concave transition areas are arranged between the chamfers. When the seal collar rotates, the concave transition areas cause a hydrodynamic pressure to build up due to the gap widths that decrease in the direction facing the direction of rotation, which results in a relief of the sliding surface. Furthermore, the chamfers are dimensioned in such a way that pressurized oil causes hydrostatic relief in the area of the chamfers. For instance, the steeper chamfer has an angle between 8° and 45°, preferably from 14° to 18°, and the flatter chamfer has an angle from 8° to 60°, preferably 45°. I.e., even when the seal collar is not rotating, pressurized oil is still in the area of the chamfers and results in the hydrostatic relief described.

The invention addresses the problem of providing a seal collar for rotary unions having a good sealing effect and low friction losses, which can be easily manufactured.

The problem of the invention relating to the rotary union is solved in that a radial chamfer hydrodynamically effective in the radial direction is provided at the at least one flank of the seal collar, which radial chamfer transitions to a flank surface of the flank at an angle α towards the clamping surface, in that the hydrodynamically effective radial chamfer has an extension in the radial direction in the range of ≥0.3 mm, preferably ≥0.5 mm and in that the hydrodynamically effective radial chamfer has a maximum axial depth in the range of 20 μm to 50 μm relative to the flank surface. Surprisingly, a chamfer on the flank of the seal collar, which starts in the radial direction and is suitably dimensioned, also results in a hydrodynamic effect, which relieves the flank in the axial direction and in that way reduces friction losses. Oil drawn into the gap formed between the chamfer and the side wall of the groove by rotation causes the hydrodynamic pressure build-up. Compared to known chamfers, as they are provided to form hydrostatically acting relief stages, the hydrodynamically acting radial chamfer has a much smaller gradient. For that reason, no hydrostatic pressure forms in the area of the hydrodynamically effective radial chamfer. The area thus contributes to the sealing of the seal collar against the side wall of the groove. The radially rising, hydrodynamically effective radial chamfer is much easier to manufacture than known hydrodynamic structures acting in the circumferential direction. In the case of such hydrodynamic structures acting in the circumferential direction, successive depressions and elevations have to be introduced into the flank of the seal collar to form the required bevels. Such structures can ultimately only be produced by embossing processes having correspondingly complex molds. The radially rising, hydrodynamically effective radial chamfer, on the other hand, can be manufactured both by embossing using considerably simpler shapes and by machining, which simplifies the production of the seal collars considerably.

The problem of the invention is further solved by the clamping surface facing the at least one lateral sealing flank at a falling angle β transitioning into an axial chamfer hydrodynamically effective in the axial direction. In the installed state, the hydrodynamically effective axial chamfer points in the direction of the pressure chamber to be sealed and rises towards the clamping surface, starting from the pressure chamber. The hydrodynamically effective axial chamfer generates a radially oriented hydrodynamic load carrying capacity in the radially outer area of the seal collar. This radially relieves the seal collar and thus reduces friction. Oil drawn into the gap between the chamfer and the housing facing the groove on a shaft or the shaft facing the groove in a housing by rotation causes the hydrodynamic pressure build-up. In addition to reduced friction, the hydrodynamically effective axial chamfer protects the housing against premature wear when the clamping surface provided with the hydrodynamically effective axial chamfer is in contact with the housing. In particular, if the housing is made of aluminum, microcracks will occur on the housing surface in the interface with the clamping surface of the seal collar. As the microcracks continue to propagate, parts can detach from the surface of the housing along the interface. They cause increased wear. After a longer period of operation, the seal collar radially beds in the housing. It is then held in the axial direction both in the groove of the shaft and in the bedded-in groove on the housing. The shaft can then no longer be disassembled. The hydrodynamically acting axial chamfer largely prevents the formation of microcracks and in that way significantly reduces the wear on the housing. This effectively prevents the seal collar from bedding in the housing and the resulting captive shaft.

According to a particularly preferred design variant of the invention, provision may be made that the seal collar has at least one hydrodynamically effective radial chamfer and at least one hydrodynamically effective axial chamfer. By forming a hydrodynamically acting chamfer on each of the two pressed-on sliding surfaces of the seal collar, its friction can be minimized and at the same time the housing can be protected against deterioration.

Optimum relief of the seal collar flank can be achieved by transitioning the hydrodynamically effective radial chamfer into the flank surface at an angle α smaller than 15° and greater than 0.5° and/or by transitioning the hydrodynamically effective axial chamfer into the clamping surface at an angle β smaller than 15° and greater than 0.5°. A hydrodynamically effective radial and/or axial chamfer designed in this way relieves the respective sliding surface, wherein keeping sufficient contact pressure to ensure the required sealing effect.

To evenly relieve the load on the flank of the seal collar and thus achieve uniform friction along the circumference and uniform rotation of the seal collar, provision may be made that the hydrodynamically effective radial chamfer and/or the hydrodynamically effective axial chamfer is arranged circumferentially on the seal collar and is interrupted at an interlock of the seal collar. Advantageously such a chamfer, which is not interrupted or only interrupted at the interlock, can be easily and therefore economically manufactured.

In addition to the hydrodynamic chamfer, further relief of the seal collar can be achieved by arranging a hydrostatic relief stage facing the clamping surface and by arranging one lateral end face of the hydrostatic relief stage set back from the hydrodynamically effective radial chamfer. The hydrostatic relief stage can be recessed by means of a step or by a bevel, which has a significantly increased angle to the flank surface compared to the hydrodynamically effective radial bevel. The hydrostatic relief stage provides additional relief for the sealing flank of the seal collar. The friction surface of the flank and the side wall of the groove is reduced without reducing the height (difference between the inner and outer radius) of the seal collar. In this way a seal collar that is mechanically sufficiently stable is achieved, wherein the contact pressure acting between the clamping surface and the assigned contact surface of the clamping surface is additionally reduced by the comparatively large height of the seal collar.

Radially oriented locating pins molded onto the seal collar facing the clamping surface can be used to accurately center the seal collar in the groove in a housing or the groove on a shaft. The locating pins facilitate in particular the installation of the shaft in the housing, because the locating pins radially symmetrically orient the seal collar(s) even without the respective clamping surfaces being in contact with the housing or the shaft. In this way, an eccentric positioning of the seal collars when installing the shaft in the housing, wherein the seal collars would block the insertion of the shaft into the housing, is prevented.

Preferably, the seal collar can be designed as an external seal collar having an outer clamping surface that is directed radially outwards or as an internal seal collar having an inner clamping surface directed radially inwards. As an external seal collar, it can be inserted in a circumferential groove in the shaft and its outer circumferential surface can be pressed against an encompassing housing or similar. As an internal seal collar, this is suitable for arrangements in which a groove in a housing is provided, into which the seal collar is inserted. The internal clamping surface of the latter is then pressed against the shaft. In both cases a hydrodynamically acting chamfer can be arranged on the individual sealing flank and/or on the clamping surface.

A straightforward installation can be achieved by making the seal collar symmetrical to a center plane transverse to its axial direction. The seal collar then has two opposing flanks, which are mirror-images of each other and at which a hydrodynamic radial chamfer is provided. In addition or alternatively, a hydrodynamically acting, axial chamfer can be provided on both sides of the clamping surface. A shaft collar designed in this way can be used in both possible installation orientations.

The problem of the invention relating to the rotary union is solved in that a radial chamfer hydrodynamically effective in the radial direction is provided at the at least one flank of the seal collar, which radial chamfer transitions to a flank surface of the flank at an angle α from the clamping surface, and in that the hydrodynamically effective radial chamfer has an extension in the radial direction of at least ≥0.3 mm, preferably ≥0.5 mm, in that the hydrodynamically effective radial chamfer has a maximum axial depth in the range of 20 μm to 50 μm relative to the flank surface, in that the flank of the seal collar covers an outer exit gap formed between the shaft and the housing or the like and facing away from the pressure chamber and rests in a contact area against an outer (relative to the pressure chamber) side wall of the groove, and in that the contact area has an extension in the radial direction greater than or equal to 0.1 mm. The hydrodynamically acting, radial chamfer relieves the flank of the seal collar, which is in contact with the side wall of the groove. The friction in this area is thus reduced. The minimum contact area provided between the flank surface and the side wall of the groove prevents the hydrodynamically acting radial chamfer of the seal collar from being the only part that rests against the side wall of the groove, which side wall on the one hand can cause increased leakage and on the other hand at least reduces the hydrodynamic effectiveness of the radial chamfer.

Preferably, provision may be made that the clamping surface facing the at least one lateral sealing flank is converted at a falling angle β into an axial chamfer, which is hydrodynamically effective in the axial direction. The hydrodynamically acting axial chamfer adjacent to the clamping surface reduces the friction between the clamping surface and the adjacent interface of the shaft or housing or the like. At the same time, increased wear of the housing can be prevented.

Preferably the rotary union has at least one seal collar having at least one of the characteristics described above.

The invention is explained in greater detail below based on exemplary embodiments shown in the drawings. In the Figures:

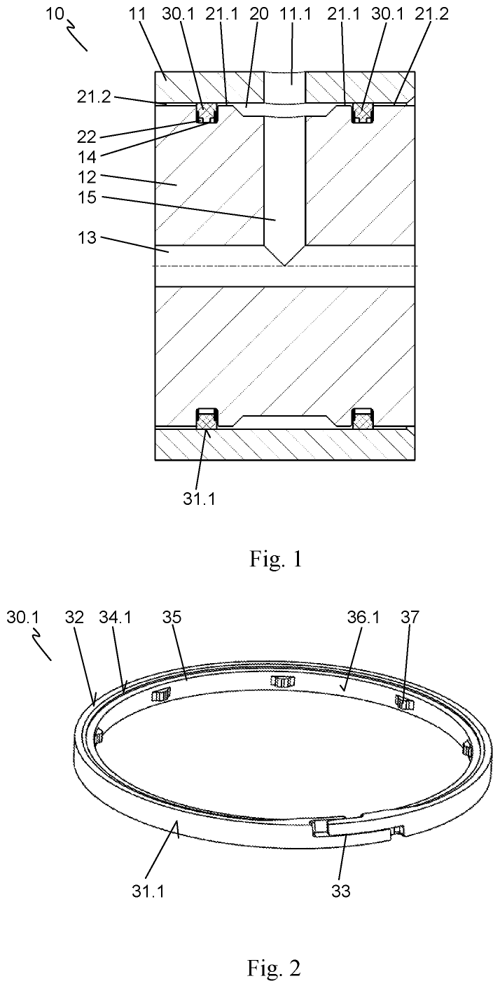

FIG. 1 shows a lateral sectional view of a rotary union having two first external seal collars,

FIG. 2 shows a perspective side view of the first external seal collar shown in FIG. 1,

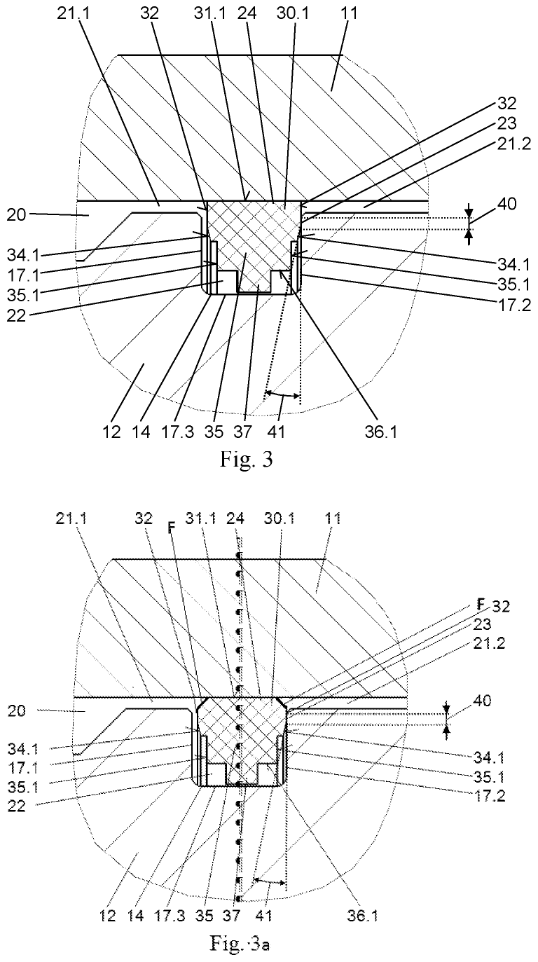

FIG. 3 shows an enlarged lateral sectional view of the first external seal collar shown in FIGS. 1 and 2,

FIG. 3a shows a modified version of the seal collars shown in FIG. 3,

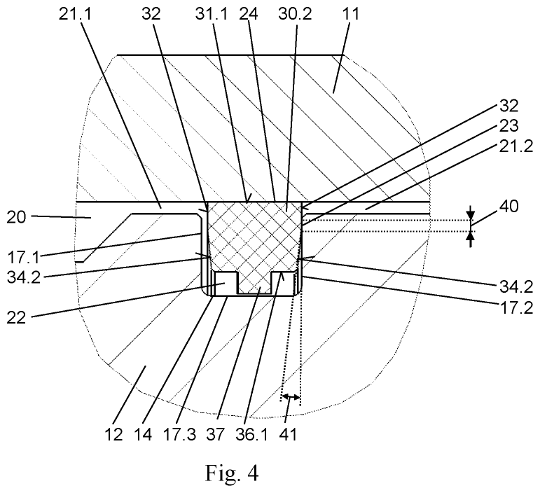

FIG. 4 shows an enlarged lateral sectional view of a second external seal collar,

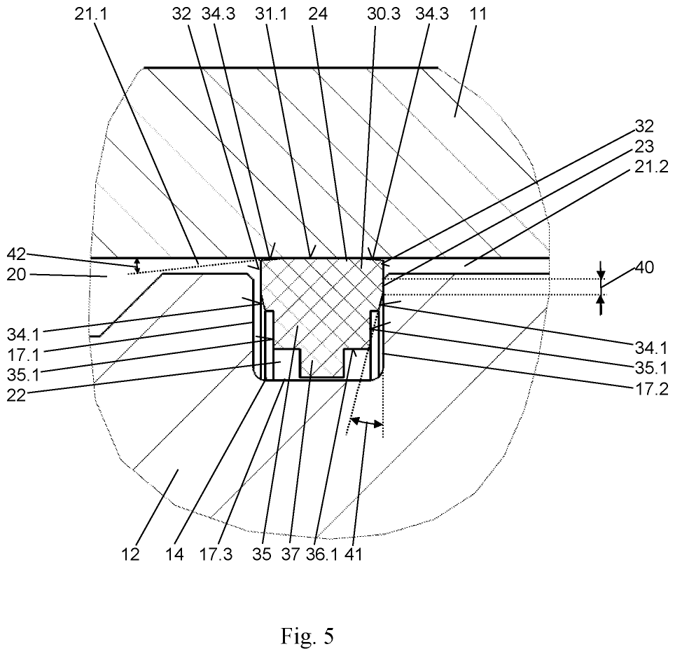

FIG. 5 shows a further enlarged lateral sectional view of a third external seal collar,

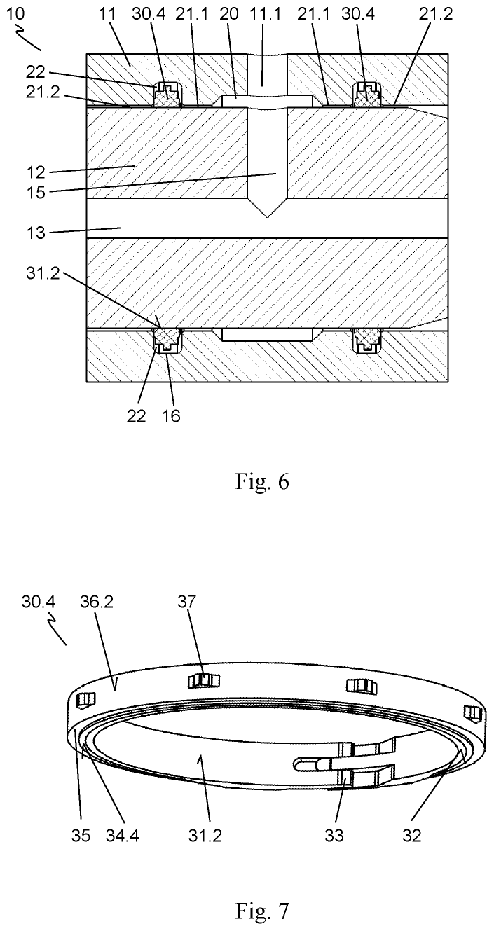

FIG. 6 shows a lateral sectional view of a rotary union having two first internal seal collars,

FIG. 7 shows a perspective side view of the first internal seal collar shown in FIG. 6,

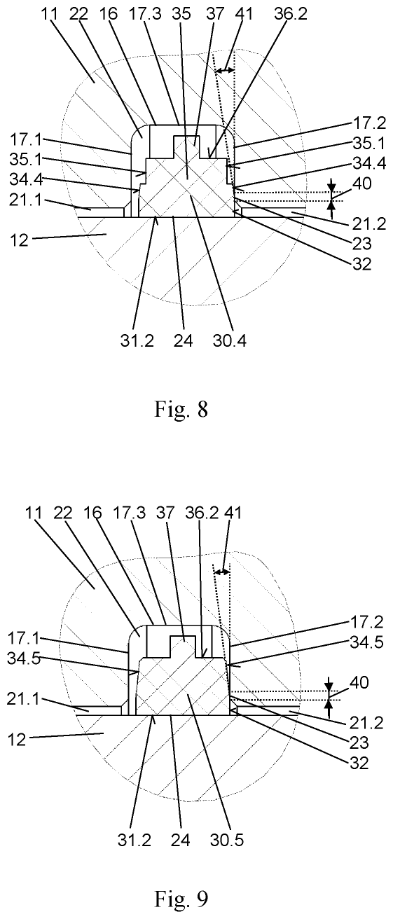

FIG. 8 shows an enlarged lateral sectional view of the first internal seal collar shown in FIGS. 6 and 7,

FIG. 9 shows an enlarged lateral sectional view of a second internal seal collar, and

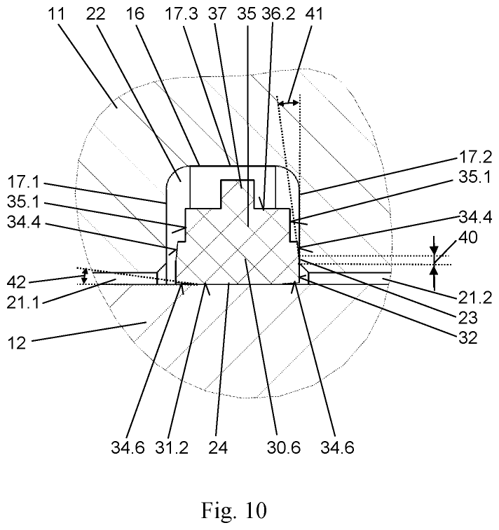

FIG. 10 shows a further enlarged lateral sectional view of a third internal seal collar.

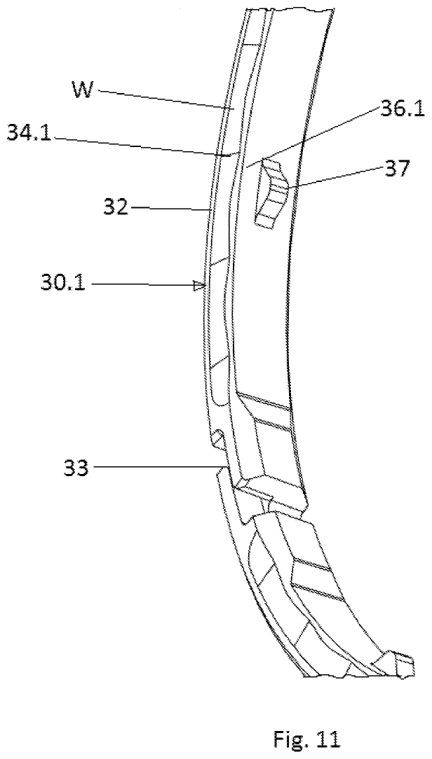

FIG. 11 shows an enlarged lateral sectional view of the first external seal collar shown in FIGS. 1 to 3 with a technical supplement.

FIG. 1 shows a lateral sectional view of a rotary union 10 having two first external seal collars 30.1. The representation and the illustrations of the subsequent FIGS. 2 to 10 are not to scale.

The first external seal collars 30.1 are each arranged in a groove space 22 of a groove on a shaft 14. The two grooves on a shaft 14 are circumferentially machined into a shaft 12. The rotatably supported shaft 12 is guided in a housing 11. Only a section of the housing 11 and the shaft 12 is shown. A pressure chamber 20 is formed as a circumferential recess in the shaft 12 between the first external seal collars 30.1. The pressure chamber 20 is connected to a central bore 13 of the shaft 12 via a radially oriented oil feed 15. The central bore 13 extends axially along the central longitudinal axis of the shaft 12. An inlet 11.1 penetrates the housing 11 in the area of the pressure chamber 20. A gap is formed between the shaft 12 and the housing 11 to permit the free rotation of the shaft 12 within the housing 11. The first two external seal collars 30.1 seal the gap on both sides of the pressure chamber 20. An inner exit gap 21.1 is thus formed facing the pressure chamber 20 and an outer exit gap 21.2 faces away from pressure chamber 20. An external clamping surface 31.1 is used to press the first external seal collars 30.1 against the housing 11. For the first external seal collars 30.1, the outer clamping surfaces of each of these collars form the outer circumferential surface 31.1.

In the exemplary embodiment shown, the rotary union 10 is part of a vehicle transmission not shown. In the transmission, pressurized oil is used to operate actuators such as a clutch or other shift elements. The oil is fed to the pressure chamber 20 via the inlet 11.1 of the housing 11. The oil supply 15 is used to feed the oil into the central bore 13 and along this bore to the actuators via the oil feed while the shaft 12 rotates. In a functional reversal, the oil can also be taken out of the central bore 13 through a corresponding rotary union 10. The highly pressurized oil is then fed from the central bore 13 via the oil feed 15 to the pressure chamber 20 and from there to the inlet 11.1 of the housing 11. From the inlet 11.1 the oil can be fed to a corresponding actuator, for instance.

Depending on the application, the oil can have a pressure of up to 8 MPa and the shaft 12 can be operated at speeds of up to 15 000 rpm. The first external seal collars 30.1 and the further seal collars 30.2, 30.3, 30.4, 30.5, 30.6 shown in FIGS. 4 to 10 seal the pressure chamber 20 along the gap formed between the shaft 12 and the housing 11, such that the required pressure is maintained and the oil leakage is kept down. The seal collars 30.1, 30.2, 30.3, 30.4, 30.5, 30.6 are exposed to high mechanical stress because of the high pressure and high speeds. The seal collars 30.1, 30.2, 30.3, 30.4, 30.5, 30.6 are made of plastic. However, it is also conceivable to use seal collars 30.1, 30.2, 30.3, 30.4, 30.5, 30.6 made of a metal, for instance cast iron.

FIG. 2 shows a perspective side view of the first external seal collar 30.1 of FIG. 1.

An interlock 33 can be used to open and close the first external seal collar 30.1. This interlock 33 is designed as a stepped interlock. However, any other suitable interlock form may be used, for instance a double T-interlock, a hook interlock or joint (scarf joint or butt joint). One such interlock 33 is provided for each of the seal collars 30.1, 30.2, 30.3, 30.4, 30.5, 30.6 shown in FIGS. 1 to 10. The seal collars 30.1, 30.2, 30.3, 30.4, 30.5, 30.6 shown are, apart from the respective areas of the interlock 33, designed as mirror images to a center plane of the respective seal collars 30.1, 30.2, 30.3, 30.4, 30.5, 30.6, which center plane is perpendicular to the axial direction. The seal collars 30.1, 30.2, 30.3, 30.4, 30.5, 30.6 can thus be installed in both possible orientations.

Starting from the outer clamping surface 31.1, the opposing flanks of the first external seal collar 30.1 each have a flank surface and an adjacent hydrodynamically effective first radial chamfer 34.1. The opposing first radial chamfers 34.1 are inclined towards each other, starting from the flank surfaces 32. Towards the inside, the first external seal collar 30.1 is closed by a hydrostatic relief stage 35. Locating pins 37 are molded onto an inner surface 36.1 of the first external seal collar 30.1 facing the outer clamping surface 31.1.

FIG. 3 shows an enlarged lateral sectional view of the first external seal collar 30.1 shown in FIGS. 1 and 2. The first external seal collar 30.1 is inserted into the groove space 22 of a groove on a shaft 14 of the rotary union 10 shown in FIG. 1. The groove space 22 is defined by a groove bottom 17.3 and one inner side wall of the groove 17.1 and one outer side wall 17.2 of the groove each, rising from the bottom 17.3 of the groove in the direction of the housing 11. The inner side wall of the groove 17.1 is arranged in the direction of the pressure chamber 20 and the outer side wall of the groove 17.2 faces the former. The outer clamping surface 31.1 of the first external seal collar 30.1 rests against the housing 11. A part of its outer flank surface 32 of the outer flank of the first external seal collar 30.1 facing to the pressure chamber 20 rests against the outer side wall of the groove 17.2 in a contact area 40. The remaining part of the outer flank surface 32 closes the outer exit gap 21.2.

A first radial chamfer 34.1 of the first external seal collar 30.1 adjoins the flank surfaces 32. For this purpose, the flank surfaces 32 are transitioned at an angle 41 into the first radial chamfers 34.1. The first radial chamfers 34.1, starting from the flank surfaces 32, are inclined inwards, i.e., towards each other, forming the angle 41. Adjacent to the first radial chamfers 34.1, the hydrostatic relief stage 35 is molded onto the first external seal collar 30.1. Lateral end faces 35.1 of the hydrostatic pressure relief stage 35 are recessed from the first radial chamfers 34.1 by one stage.

The locating pins 37, a sectional view of one of which is shown in in the diagram in FIG. 3, are molded onto the inner surface 36.1 and are adjacent to or directly facing the bottom of the groove 17.3. As a result, the first external seal collar 30.1 is radially oriented with relation to the shaft 12 during installation if the shaft 12 has not yet been inserted into the housing 11. In that way, the shaft 12 having the first external seal collar 30.1 can be inserted into the housing 11 without the first external seal collar 30.1 blocking the insertion movement by eccentric positioning. To facilitate installation, the external seal collar 30.1 may also be provided with an installation chamfer F, as shown in FIG. 3A. The installation chamfer is located in the transition area between the flank surface(s) 32 and the clamping surface 31.1. In addition or alternatively, provision may also be made that the housing 11 is provided with an appropriate installation chamfer.

The inner outlet exit gap 21.1 connects the pressure chamber 20 to the groove space 22. As a result, a high oil pressure develops in the groove space 22. It presses the outer clamping surface 31.1 of the first external seal collar 30.1 against the housing 11 and the outer flank surface 32 of the first external seal collar against the outer side wall of the groove 17.2 in the contact area 40. A sealing gap 23 on the flank side between the flank surface 32 and the side wall of the groove 17.2 and a sealing gap 24 at the circumferential surface between the outer clamping surface 31.1 and the housing 11 are largely closed because of this contact pressure. Therefore, only a small oil leakage flow can flow out of the groove space 22 through the sealing gap 23 on the flank end and the sealing gap 24 at the circumferential surface to the outer exit gap 21.2.

The lateral faces 35.1 of the hydrostatic relief stage 35 are set back from the flank surfaces 32 to such an extent that the pressurized oil in the groove space 22 is also pressurized between the lateral face 35.1 and the outer side wall of the groove 17.2. The oil pressure acting on the lateral face 35.1 facing the pressure chamber 20 is thus compensated by the oil pressure acting on the lateral face 35.1 of the hydrostatic pressure relief stage 35 facing the outer side wall of the groove 17.2. This measure reduces the pressure with which the flank surface 32 of the first external seal collar 30.1 is pressed against the outer side wall of the groove 17.2 in the contact area 40, wherein by the same token a sufficient material thickness of the first external seal collar 30.1 is obtained in the radial direction. The reduced contact pressure of the first external seal collar 30.1 at the outer side wall of the groove 17.2 reduces the friction between the first external seal collar 30.1 and the outer side wall of the groove 17.2 in addition to the wear of the first external seal collar 30.1 and the side wall of the groove 17.2. Because of the increased material thickness of the first external seal collar 30.1 in the radial direction as a result of the hydrostatic relief stage, the contact pressure of the outer clamping surface 31.1 and thus the friction and wear in this area are reduced.

The hydrodynamically effective, first radial chamfer 34.1 has an extension in the radial direction of ≥0.3 mm, preferably of ≥0.5 mm. It represents a bevel opening up towards the groove space 22. It has a maximum distance of 20 μm to 50 μm from the plane of the flank surface 32 measured in the axial direction. This maximum distance is thus formed at the end of the hydrodynamically effective, first radial chamfer 34.1 facing away from the outer clamping surface 31.1. The hydrodynamically effective radial chamfers 34.1, 34.2, 34.4, 34.5 transition into the respective flank surfaces 32 at an angle 41 smaller than 15° and greater than 0.5°. For an improved illustration, the angle 41 and the maximum distance are enlarged and therefore not drawn to scale. The angle 41 or the maximum distance between the hydrodynamically acting, first radial chamfers 34.1 and the outer side wall of the groove 17.2 are too small for any hydrostatic oil pressure to build up in the area of the hydrodynamically acting, first radial chamfer 34.1. In that way, the area of the hydrodynamically effective first radial chamfer 34.1 contributes to the sealing of the groove space 22 and thus of the pressure chamber 20. During operation when the shaft 12 rotates, oil penetrates into the area of the hydrodynamically effective first radial chamfer 34.1 because of centrifugal forces and the existing oil pressure. The oil trying to move outward runs against the tapering gap of the first radial chamfer 34.1. This creates a hydrodynamic effect in the radial direction. The associated pressure build-up occurs mainly in the transition area from the hydrodynamically effective first radial chamfer 34.1 to the adjacent flank surface 32. As a result of this pressure build-up, the first external seal collar 30.1 is depressurized in the axial direction in its contact area 40 to the outer side wall of the groove 17.2. This significantly reduces friction and/or wear between the side wall of the groove 17.2 and the first external seal collar 30.1. The hydrodynamic effect is advantageous regardless of the direction of rotation of the shaft 12.

The design of the hydrodynamically effective first radial chamfer 34.1 in accordance with the invention ensures that the hydrodynamically caused increase in oil pressure is just large enough for sufficient contact pressure of the flank surface 32 against the outer side wall of the groove 17.2 to be maintained. In this way, the oil leakage is kept down.

The contact area 40 has an extension that is larger than or equal to 0.2 mm in the radial direction. Possible manufacturing tolerances of the housing 11, the shaft 12 and the first external seal collar 30.1 are taken into account. The specification of the contact area 40 ensures that a sufficiently large surface of the hydrodynamically effective first external seal collar 30.1 rests against the outer side wall of the groove 17.2. This prevents an increased leakage flow. Furthermore, the hydrodynamically effective first radial chamfer 34.1 is not partially located in the area of the outer exit gap 21.2, which would result in the hydrodynamic effect being lost.

FIG. 4 shows an enlarged lateral sectional view of a second external seal collar 30.2.

The design of the shaft 12 with the groove on a shaft 14 and the housing 11 with the inner and outer exit gaps 21.1, 21.2 correspond to the description in FIG. 3, to which reference is made.

The outer clamping surface 31.1 of the second external seal collar 30.2 also rests against the housing 11 and seals the sealing gap 24 at the circumferential surface. As described in FIG. 3, one of the opposing flank surfaces 32 lies against the outer side wall of the groove 17.2 in the contact area 40, thus sealing the sealing gap 23 at the flank. The flank surfaces 32 merge into a hydrodynamically effective second radial chamfer 24.2 at the angle 41 described previously. In contrast to the first external seal collar 30.1 shown in FIG. 3, the second external seal collar 30.2 does not have a hydrostatic relief stage 35. The locating pins 37 are molded onto the inner surface 36.1 of the second external seal collar 30.2 having the same function as described in FIG. 3.

The hydrodynamically effective, second radial chamfer 34.2 also has an extension in the radial direction in the range of ≥0.3 mm, preferably ≥0.5 mm. It represents a bevel opening up towards the groove space 22. It has a maximum distance in the range of 20 μm to 50 μm from the plane of the flank surface 32 measured in the axial direction. The contact area 40 has an extension that is larger than or equal to 0.2 mm in the radial direction.

With the exception of the absence of the hydrostatic relief stage 35, the mode of operation and function of the second external seal collar 30.2 thus corresponds to the mode of operation and function of the first external seal collar 30.1 shown in FIG. 3, to the description of which reference is made.

FIG. 5 shows a further enlarged lateral sectional view of a third external seal collar 30.3. The flanks of the third external seal collar with the flank surfaces 32, the first radial chamfers 34.1 and the lateral surfaces 35.1 of the hydrostatic relief stage 35 and the locating pins 37 correspond to the flanks or locating pins 37 of the first external seal collar 30.1, i.e., the relevant description in this respect is also applicable to the third external seal collar 30.3.

In contrast to the first external seal collar 30.1, hydrodynamically effective first axial chamfers 34.3 are provided laterally from the outer clamping surface 31.1. Starting from the outer clamping surface 31.1, the hydrodynamically effective first axial chamfer 34.3 facing the pressure chamber 20 forms a bevel open towards the groove space 22. The largest distance between the circumference of the outer clamping surface 31.1 and the hydrodynamically effective first axial chamfer 34.3 is thus always at the edge of the third outer clamping seal collar 30.3. Because of the symmetrical design of the third external seal collar 30.3, a first axial chamfer 34.3 is also provided towards the outer side wall of the groove 17.2, which however has no hydrodynamic effect in the installation situation shown.

Compared to the outer clamping surface 31.1, the first axial chamfers 34.3 are oriented at an angle 42 smaller than 0.01° and larger than 0.001°.

A hydrodynamic effect occurs along the first axial chamfer 34.3 facing the pressure chamber 20. Due to the oil leakage flow flowing along the sealing gap 24 at the circumferential surface, a hydrodynamically increased oil pressure forms in the area of the rising chamfer of the first axial chamfer 30.3 and the adjacent outer clamping surface 31.1. The latter reduces the contact pressure of the third external seal collar 30.3 against the housing 11. This reduces the friction between the third external seal collar 30.3 and the housing 11. Furthermore, there is a reduced alternating load to the housing 11, which in this case is made of aluminum. Such an alternating load causes micro-cracks in the boundary area between the third external seal collar 30.3 and the housing 11. As the crack depth progresses, parts become detached from the interface, which then results in increased wear. The third external seal collar 30.3 then beds in the housing 11, preventing the shaft 12 from being disassembled. The hydrodynamic relief of the third external seal collar 30.3 effectively prevents the formation of microcracks. The wear of the housing 11 and also of the third external seal collar 30.3 is thus kept low and the shaft 12 can be pulled out of the housing 11 without any problems even after a long period of operation.

The first radial chamfer 34.1 facing the outer side wall of the groove 17.2 and the first axial chamfer 34.3 facing the pressure chamber 20 are ultimately responsible for the hydrodynamic relief of the third external seal collar 30.3. The first radial and axial chamfers 34.1, 34.3 arranged facing each other are not necessary for the function in this installation situation. However, the symmetrical design of the third external seal collar 30.3 has the advantage that the third external seal collar 30.3 can be used in both possible installation situations. Compared to hydrodynamic structures periodically machined into the flank surfaces 32 or the outer clamping surface 31.1, the first radial chamfer 34.1 and the first axial chamfer 34.3 have the advantage of simple manufacture and the independence of their mode of operation from the respective direction of rotation.

FIG. 6 shows a lateral sectional view of a rotary union 10 having two first internal seal collars 30.4.

The rotary union 10 is assigned to the rotatably supported shaft 12 with the central bore 13 and to the housing 11 enclosing the shaft 12 at least in sections. The pressure chamber 20 is incorporated into the housing 11 as a circumferential recess. The former is accessible from the outside via the inlet 11.1 and is connected to the central bore 13 via the oil feed 15. On the side of the pressure chamber 20, a groove in a housing 16 is set into the housing 11. A first internal seal collar 30.4 is arranged in each of the grooves in a housing 16. The first internal seal collar 30.4 seals the inner exit gap 21.1 against the outer exit gap 21.2. For this purpose, the first internal seal collars 30.4, each with an internal clamping surface 31.2, are pushed onto the shaft 11.

The function and use of the rotary union 10 shown in FIG. 6 is the same as the function and use of the rotary union 10 shown in FIG. 1, the description of which is referred to.

FIG. 7 shows a perspective side view of the first internal seal collar 30.4 of FIG. 6. The first internal seal collar 30.4 can be opened and closed by means of an interlock 33, which is designed as a T-interlock here. As a result, the comparatively rigid first internal seal collar 30.4 can be installed in the groove in a housing 16 provided. The inner clamping surface 31.2 is formed on an inner circumferential surface of the first internal seal collar 30.4. The first internal seal collar 30.4 is symmetrically constructed with respect to a center plane oriented transversely to its center axis. Thus, the facing flanks of the first internal seal collar 30.4, adjacent to the inner clamping surface 31.2, initially form flank surfaces 32, which are aligned in parallel to each other. The flank surfaces 32 transition into the third radial chamfers 34.4 at an angle α 41 (see FIG. 8). The third radial chamfers 34.4 are oriented such that, starting from the flank surfaces 32, they converge towards each other. Following the third radial chamfers 34.4, the first internal seal collar 30.4 transitions stepwise into a hydrostatic relief stage 35. This forms an outer surface 36.2 of the first internal seal collar. Along the outer surface 36.2 there are locating pins 37 spaced apart from each other.

FIG. 8 shows an enlarged lateral sectional view of the first internal seal collar 30.4 shown in FIGS. 6 and 7.

The inner clamping surface 31.2 of the first internal seal collar 30.4 rests against the shaft 12. As a result, a sealing gap 24 at the circumferential surface between the inner clamping surface 31.2 and the shaft 12 is sealed. The flank surface 32 of first internal seal collar 30.4 facing away from the inner exit gap 21.1, and thus from the pressure chamber 20, rests against the outer side wall of the groove 17.2 in the contact area 40, effectively sealing the sealing gap 23 at the flank.

Starting from the flank surfaces 32, the third radial chamfers 34.4 form wedge-shaped bevels that open continuously towards the groove bottom 17.3. The third radial chamfer 34.4 on the outer side wall of the groove 17.2 is hydrodynamically effective. The dimensioning of the third radial chamfer 34.4 matches that of the dimensioning of the first radial chamfer 34.1 shown in FIG. 3. Here, too, the flank surfaces 32 transition into the first radial chamfers 34.1 at an angle α, which is smaller than 0.01° and greater than 0.001°.

The function of the hydrostatic relief stage 35 and the locating pin 37 has been described for the first external seal collar 30.1 in FIG. 3 above and also applies to the first internal seal collar 30.4.

The high oil pressure in the groove space 22 presses the inner clamping surface 31.2 of the first internal seal collar 30.4 against the shaft 12 and one flank surface 32 in the contact area 40 against the outer side wall of the groove 17.2. In that way, the outer exit gap 21.2 is sealed against the groove space 22 and thus against the pressure chamber 20.

Because of the high oil pressure in the groove space 22, oil tries to flow along the flank-side sealing gap 23 to the outer exit gap 21.2. A hydrodynamic effect is created by the tapering gap formed between the outer side wall of the groove 17.2 and the third radial chamfer 34.4. This results in an increase in oil pressure in the area of the third radial chamfer 34.4 adjacent to the outer side wall of the groove 17.2, the adjacent flank surface 32 and the facing outer side wall of the groove 17.2. This reduces the contact pressure of the first internal seal collar 30.4 in the contact area 40 against the outer side wall of the groove 17.2, resulting in reduced friction and wear.

The contact area 17.2 has an extension that is larger than or equal to 0.2 mm in the radial direction.

FIG. 9 shows an enlarged lateral sectional view of a second internal seal collar 30.5. In accordance with the second external seal collar 30.2 shown in FIG. 4, no hydrostatic relief stage 35 is provided here either. The formed fourth radial chamfers 34.5 are thus routed at an angle α 41 inclined to the flank surfaces 32 up to the outer surface 36.2 of the second internal seal collar 30.5. In a round area, they transition into the outer surfaces 36.2. The function of the fourth radial chamfers 34.5 matches the function of the third radial chamfers 34.4 described in FIG. 8.

FIG. 10 shows a further enlarged lateral sectional view of a third internal seal collar 30.6. The design of the third internal seal collar 30.6 essentially equals that of the first internal seal collar 30.4, wherein in addition to the opposing edges of the inner clamping surface 31.2, second hydrodynamically effective axial chamfers 34.6 are arranged. In the installation situation shown, the second axial chamfer 34.6 facing the inner exit gap 21.1 and thus the pressure chamber 20 is hydrodynamically effective.

As previously described for the third external seal collar 30.3, the hydrodynamically effective second axial chamfer 34.6 causes a relief of the third internal seal collar 30.6 along its inner clamping surface 31.2. This can reduce friction and wear in this area.

In summary, it can be said that the hydrodynamically effective radial chamfers 34.1, 34.2, 34.4, 34.5 facing the respective outer side wall of the grooves 17.2 relieve the respective flank surfaces 32 of the seal collars 30.1, 30.2, 30.3, 30.4, 30.5, 30.6. This reduces both friction and wear in this area. The hydrodynamically effective axial chamfers 34.3, 34.6 relieve the contact pressure along the respective clamping surfaces 31.1, 31.2 of the seal collars 30.1, 30.2, 30.3, 30.4, 30.5, 30.6. This also reduces both friction and wear. If the clamping surface 31.1, 31.2 of a seal collar 30.1, 30.2, 30.3, 30.4, 30.5, 30.6 rests against an adjacent component (housing 11 or shaft 12) made of aluminum, the formation of microcracks in the aluminum surface can be prevented by relieving the clamping surface 31.1, 31.2. This prevents the respective seal collar 30.1, 30.2, 30.3, 30.4, 30.5, 30.6 from bedding in the aluminum surface, which would block the removal of the shaft 12 from the housing 11.

To achieve the hydrodynamic relief of the flank surfaces 32 of the seal collars 30.1, 30.2, 30.3, 30.4, 30.5, 30.6, the hydrodynamically effective radial chamfers 34.1, 34.2, 34.4, 34.5 have an extension of ≥0.3 mm, preferably ≥0.5 mm, in the radial direction and a maximum depth of 20 μm to 50 μm relative to the respective flank surfaces 32. The hydrodynamically effective radial chamfers 34.1, 34.2, 34.4, 34.5 transition into the respective flank surfaces 32 at an angle 41 smaller than 15° and greater than 0.5°.

A hydrodynamic relief of the clamping surface 31.1, 31.2 is achieved if the hydrodynamically effective axial chamfers 34.3, 34.6 transition into the assigned clamping surfaces 31.1, 31.2 at an angle β 42 smaller than 0.01° and greater than 0.001°.

With such a design of the radial and/or axial chamfers 34.1, 34.2, 34.3, 34.4, 34.5, 34.6, a sufficient relief of the seal collars 30.1, 30.2, 30.3, 30.4, 30.5, 30.6 is achieved, wherein at the same time a sufficient contact pressure is maintained to sufficiently seal the sealing gap 23, 24 on the flank or circumferential surface and thus keep the oil leakage flow at a low level. The exact design of the radial and/or axial chamfers 34.1, 34.2, 34.3, 34.4, 34.5, 34.6 is selected within the scope of the ranges defined by the invention as a function of at least the individual oil pressure and the speed of the shaft 12.

FIG. 11 shows the seal collar 30.1 shown in FIGS. 1 to 3, wherein a change has been made in the area of the first radial chamfer 34.1 compared to the design in FIG. 3. As the illustration shows, the surface area of the first radial phase is provided with an undulating structure. This undulating structure W forms a hydrodynamically effective contour, wherein the crests and troughs extend in a radial direction or in a largely radial direction. It is also conceivable that the crests and the troughs are inclined to the radial direction. This hydrodynamically effective contour can be used to increase the load capacity of the seal collar 30.1 in the area of the radial chamfer 34.1 in favor of an improved support behavior.

1. A seal collar (30.1, 30.2, 30.3, 30.4, 30.5, 30.6) for installation in a groove on a shaft (14) or in a groove in a housing (16) for sealing a rotating shaft (12) relative to a stationary housing (11) or the like, having at least one lateral flank for contact and sealing on a side wall of the groove (17.1, 17.2) of the groove on a shaft (14) or the groove in a housing (16) and having a clamping surface (31.1, 31.2) directly or indirectly adjoining the flank at an angle for contact and sealing at the housing (11) facing the groove on a shaft (14) or on the shaft (12) facing the groove in a housing (16),
characterized
in that a radial chamfer (34.1, 34.2, 34.4, 34.5) which is hydrodynamically effective in the radial direction is provided at the at least one flank, which radial chamfer transitions into a flank surface (32) of the flank from the clamping surface (31.1, 31.2) at an angle (41), in that the hydrodynamically effective radial chamfer (34.1, 34.2, 34.4, 34.5) has an extension in the radial direction in the range of ≥0.3 mm, preferably ≥0.5 mm, and in that the hydrodynamically effective radial chamfer (34.1, 34.2, 34.4, 34.5) has a maximum axial depth in the range of 20 μm to 50 μm relative to the flank surface (32).

2. A seal collar (30.1, 30.2, 30.3, 30.4, 30.5, 30.6) for installation in a groove on a shaft (14) or in a groove in a housing (16) for sealing a rotating shaft (12) relative to a stationary housing (11) or the like, having at least one lateral sealing flank for contact and sealing on a side wall of the groove (17.1, 17.2) of the groove on a shaft (14) or the groove in a housing (16) and having a clamping surface (31.1, 31.2) directly or indirectly adjoining the flank at an angle for contact and sealing at the housing (11) facing the groove on a shaft (14) or on the shaft (12) facing the groove in a housing (16),
characterized
in that the clamping surface (31.1, 31.2) facing the at least one lateral sealing flank transitions at a falling angle (42) into an axial chamfer (34.3, 34.6) hydrodynamically effective in the axial direction.

3. The seal collar (30.1, 30.2, 30.3, 30.4, 30.5, 30.6) according to claim 1 or 2, characterized in that the seal collar (30.1, 30.2, 30.3, 30.4, 30.5, 30.6) has at least one hydrodynamically effective radial chamfer (34.1, 34.2, 34.4, 34.5) and at least one hydrodynamically effective axial chamfer (34.3, 34.6)

4. The seal collar (30.1, 30.2, 30.3, 30.4, 30.5, 30.6) according to any one of the claims 1 to 3, characterized in that the hydrodynamically effective radial chamfer (34.1, 34.2, 34.4, 34.5) transitions into the flank surface (32) at an angle (41) smaller than 15° and greater than 0.5° and/or that the hydrodynamically active axial chamfer (34.3, 34.6) transitions into the clamping surface (31.1, 31.2) at an angle (42) smaller than 15° and greater than 0.5°.

5. The seal collar (30.1, 30.2, 30.3, 30.4, 30.5, 30.6) according to any one of the claims 1 to 4, characterized in that the hydrodynamically effective radial chamfer (34.1, 34.2, 34.4, 34.5) and/or the hydrodynamically effective axial chamfer (34.3, 34.6) is/are arranged circumferentially on the seal collar (30.1, 30.2, 30.3, 30.4, 30.5, 30.6) and is/are interrupted at an interlock (33) of the seal collar (30.1, 30.2, 30.3, 30.4, 30.5, 30.6).

6. The seal collar (30.1, 30.2, 30.3, 30.4, 30.5, 30.6) according to any one of claims 1 to 5, characterized in that a hydrostatic relief stage (35) is arranged facing the clamping surface (31.1, 31.2) and in that a lateral face (35.1) of the hydrostatic relief stage (35) is arranged set back relative to the hydrodynamically effective radial chamfer (34.1, 34.2, 34.4, 34.5).

7. The seal collar (30.1, 30.2, 30.3, 30.4, 30.5, 30.6) according to any one of the claims 1 to 6, characterized in that locating pins (37) radially oriented facing the clamping surface (31.1, 31.2) are molded onto the seal collar (30.1, 30.2, 30.3, 30.4, 30.5, 30.6).

8. The seal collar (30.1, 30.2, 30.3, 30.4, 30.5, 30.6) according to any one of the claims 1 to 7, characterized in that the seal collar (30.1, 30.2, 30.3, 30.4, 30.5, 30.6) is designed as an external seal collar (30.1, 30.2, 30.3, 30.4, 30.5, 30.6) having a radially outwardly directed, outer clamping surface (31.1) or as an internal seal collar (30.1, 30.2, 30.3, 30.4, 30.5, 30.6) having a radially inwardly directed, inner clamping surface (31.2).

9. The seal collar (30.1, 30.2, 30.3, 30.4, 30.5, 30.6) according to any one of the claims 1 to 8, characterized in that the seal collar (30.1, 30.2, 30.3, 30.4, 30.5, 30.6) is designed symmetrically with respect to a central plane formed transversely to its axial direction.

10. A rotary union (10) having a rotatable shaft (13) and a housing (11) or the like at least partially enclosing the shaft (13), wherein a pressure chamber (20) is arranged between the shaft (13) and the housing (11), which pressure chamber is sealed in the axial direction in each case by a seal collar (30.1, 30.2, 30.3, 30.4, 30.5, 30.6) arranged in a groove on a shaft (14) or a groove in a housing (16), wherein the seal collar (30.1, 30.2, 30.3, 30.4, 30.5, 30.6) has a lateral flank for contact and sealing on a side wall of the groove (17.1, 17.2) of the groove on a shaft (14) or the groove in a housing (16) and a clamping surface (31.1, 31.2) adjoining the flank indirectly or directly at an angle for contact and sealing on the housing (11) facing the groove on a shaft (14) or on the shaft (12) facing the groove in a housing (16),
characterized
in that a radial chamfer (34.1, 34.2, 34.4, 34.5, 34.5) hydrodynamically effective in the radial direction, is provided on at least one flank of the seal collar (30.1, 30.2, 30.3, 30.4, 30.5, 30.6), which chamfer transitions into a flank surface (32) of the flank at an angle (41) from the clamping surface (31.1, 31.2), in that the hydrodynamically effective radial chamfer (34.1, 34.2, 34.4, 34.5) has an extension in the radial direction in the range of 0.3 mm, preferably 0.5 mm, in that the hydrodynamically effective radial chamfer (34.1, 34.2, 34.4, 34.5) axially has a maximum depth in the range from 20 μm to 50 μm relative to the flank surface (32), in that the flank surface (32) of the seal collar (30.1, 30.2, 30.3, 30.4, 30.5, 30.6) covers an outer exit gap (21.2) formed between the shaft (12) and the housing (11) or the like and facing away from the pressure chamber (20), and rests in a contact area (40) against an outer side wall of the groove (17.2) in relation to the pressure chamber (20), and in that the contact area (17.2) has an extension in the radial direction greater than or equal to 0.2 mm.

11. The rotary union (10) according to claim 10,
characterized
in that the clamping surface (31.1, 31.2) facing the at least one lateral sealing flank transitions at a falling angle (42) into an axial chamfer (34.3, 34.6) hydrodynamically effective in the axial direction.

12. The rotary union (10) according to claim 10 or 11 having at least one seal collar (30.1, 30.2, 30.3, 30.4, 30.5, 30.6) according to any one of the claims 1 to 6.
